(19) United States
(12) Patent Application Publication
(10) Pub. No.: US 2026/0243624 A1
(43) Pub. Date: Aug. 20, 2026

(54) SYSTEM FOR EVALUATING PERFORMANCE OF VEHICLE HEADLAMP ASSEMBLIES

(71) Applicant: ISOQA TECHNICAL SERVICE LLC, Farmington, MI (US)

(72) Inventor: Chihhua Chang, Farmington, MI (US)

(73) Assignee: ISOQA TECHNICAL SERVICE LLC, Farmington, MI (US)

(21) Appl. No.: 19/153,843

(22) PCT Filed: Feb. 6, 2023
(86) PCT No.: PCT/US2023/062045

§ 371 Date: Aug. 5, 2025

(51) Int. Cl. G01M 11/04; B60Q 1/08; G01M 11/06

(52) U.S. Cl. CPC G01M 11/04; B60Q 1/085; G01M 11/061; B60Q 2300/42; B60Q 2300/43

(57) ABSTRACT

A system arranged in an X-Y-Z coordinate frame for testing a motor vehicle headlamp assembly. The system also includes a first fixture configured to support the headlamp assembly. The system additionally includes first and second rails, each parallel to an X-axis, and a third rail arranged on a Y-axis and configured to traverse the first and second rails toward and away from the first fixture. The system also includes a rotary table mounted to the third rail and configured to selectively shift along the third rail, shift along a Z-axis, and turn about the Z-axis in the X-Y plane and a second fixture mounted to the rotary table. Furthermore, the system includes an electronic controller configured to regulate movement of the third rail and the rotary table during operation of the headlamp assembly.

### INTRODUCTION

The disclosure relates to a system, including a testing station inside a controlled environment, for evaluating performance of motor vehicle headlamp assemblies.

Motor vehicles are typically equipped with exterior lighting systems to provide exterior illumination for the operator to safely operate the vehicle in low-light conditions, such as nighttime driving, and to increase the conspicuity of the vehicle. Such lighting systems also display information about the vehicle's presence, position, size, direction of travel, as well as providing signaling functions to indicate the operator's intended maneuvering of the vehicle, for example, to operators of other, approaching vehicles. A headlamp is generally a lighting unit or module attached to the front of a vehicle to illuminate the road ahead of the subject vehicle.

Headlamps are designed to provide wide visibility for the host vehicle's driver, while avoiding glaring to oncoming or leading vehicles. A headlamp alternatively provides low beam and high beam illumination. Low beam generates a distribution of light designed to provide forward and lateral illumination, with limits on light directed towards the eyes of other road users to control glare. Accordingly, low beam is intended for use whenever other vehicles are present ahead, whether oncoming or being overtaken by the host vehicle. High beam, a.k.a. driving beam, generally has a bright, center-weighted distribution of light with no particular control of light directed towards other road users' eyes. High beam is primarily suitable for use when the host vehicle is alone on the road, as the glare the high beam produces will typically dazzle other drivers.

Prior to a new headlamp design being installed on road vehicles, the lighting system is typically tested and its performance is validated. Lighting system testing is generally subject to predefined performance criteria and is performed under controlled conditions to ensure the test's repeatability and reliability of the results. Such testing may be done on individual headlamp assemblies in laboratory conditions and/or on actual vehicles in various ambient conditions and on a variety of roads. Testing of lighting systems may include measurements of light output, beam pattern, and glare at particular distances, as defined by various government bodies and regulations.

### SUMMARY

A system arranged in an X-Y-Z coordinate frame for evaluating performance of a motor vehicle headlamp assembly. The system also includes a first fixture configured to support the headlamp assembly. The system additionally includes first and second rails, each parallel to an X-axis. The system also includes a third rail arranged transverse to the X-axis on a Y-axis and configured to traverse the parallel first and second rails such that the third rail selectively shifts toward and away from the first fixture. The system additionally includes a rotary table mounted to the third rail. The rotary table is configured to selectively shift along the third rail, shift along a Z-axis, and turn about the Z-axis axis in an X-Y plane. The system also includes a second fixture mounted to the rotary table. Furthermore, the system includes an electronic controller configured to regulate operation of the movement of the third rail and the rotary table to simulate relative motion between first and second motor vehicles represented by the first and second fixtures during operation of the headlamp assembly.

The evaluated headlamp assembly may be an adaptive driving beam (ADB) headlamp assembly having a light segment array selectable to generate a plurality of beam patterns. The ADB headlamp assembly may be configured to generate a predetermined beam pattern in response to the movement of the third rail and the rotary table.

The system may additionally include a first sensor in communication with the electronic controller, mounted to the first fixture, and configured to detect a distance between the first and second fixtures.

The first sensor may be a laser measurement device.

The system may additionally include one or more second sensors in communication with the electronic controller, mounted to the second fixture, and configured to detect performance of the headlamp assembly.

Each second sensor may be configured as a LUX meter set up to detect luminous intensity of the headlamp assembly.

The electronic controller may be in wired communication with the second sensor(s).

The system may additionally include a platform having a gantry structure having a height, a width, and a length and defining an internal under-platform space between the parallel first and second rails. In such an embodiment, each of the first fixture, the first rail, and the second rail may be mounted to the platform and the rotary table and the second fixture may either extend into the under-platform space or be arranged above the under-platform space.

Alternatively, the system may mount the first and second rails near a foundation and also include a cross-bridge with the third rail being part thereof. The cross-bridge may span a distance between the parallel first and second rails, thereby positioning the third rail at a predetermined height relative to the parallel first and second rails. In such an embodiment, the rotary table and the second fixture may be mounted either under the cross-bridge or over the cross-bridge.

The system may additionally include a first electric motor configured to turn the rotary table about the Z-axis.

The system may also include a second electric motor configured to shift the rotary table along the third rail.

The system may additionally include a third electric motor configured to shift the third rail relative to the parallel first and second rails.

The first fixture may be selectively adjustable to shift relative to the platform.

A controlled environment indoor testing station with an enclosed structure defining an interior space in an X-Y-Z coordinate frame to accommodate the above-described system for evaluating the motor vehicle headlamp assembly is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1A is a schematic perspective illustration of a system for evaluating performance of a motor vehicle headlamp assembly; the system having first, second, and third rails, a platform, a first fixture supporting the headlamp assembly and moveably mounted to the platform, a rotary table moveably mounted to the platform and supporting a second fixture, and an electronic controller configured to regulate operation of the system, according to the disclosure.

FIG. 1B is a schematic perspective illustration of another embodiment of the system for evaluating performance of a motor vehicle headlamp assembly, depicting the third rail shown in FIG. 1A mounted to a cross-bridge, according to the disclosure.

FIG. 2 is a schematic close-up perspective view of the first fixture shown in FIGS. 1A and 1B, with the headlamp assembly, filters, and first sensor mounted thereto, according to the disclosure.

FIG. 3 is a schematic close-up perspective view of one embodiment of the second fixture shown in FIGS. 1A and 1B, with test stimuli and second sensors mounted thereto, according to the disclosure.

FIG. 4 is a schematic close-up perspective view of another embodiment of the second fixture shown in FIGS. 1A and 1B, with test stimuli and second sensors mounted thereto, according to the disclosure.

FIG. 5 is a schematic perspective view of the headlamp assembly shown in FIGS. 1A and 1B, the headlamp assembly depicted as an adaptive driving beam (ADB) assembly having a light segment array selectable to generate a plurality of light beam patterns.

FIG. 6 is a schematic top view of first and second motor vehicles traveling on a road surface in same direction, with the first vehicle generating light beams toward the second vehicle via its headlamp assemblies, wherein the relative motion between the vehicles is simulated by the system shown in FIGS. 1A and 1B, according to the disclosure.

FIG. 7 is a schematic top view of first and second motor vehicles shown in FIG. 6, but traveling in opposite directions, wherein the relative motion between the vehicles is simulated by the system shown in FIGS. 1A and 1B, according to the disclosure.

### DETAILED DESCRIPTION

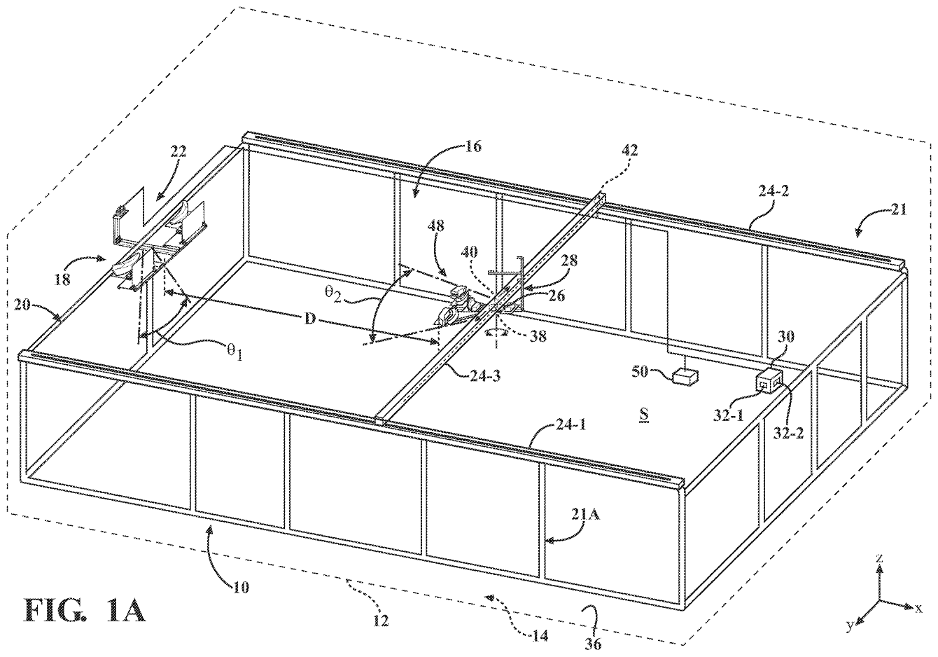

Those having ordinary skill in the art will recognize that terms such as “above”, “below”, “upward”, “downward”, “top”, “bottom”, “left”, “right”, etc., are used descriptively for the figures, and do not represent limitations on the scope of the disclosure, as defined by the appended claims. Referring to the drawings, wherein like reference numbers refer to like components, FIGS. 1-4 show various views and embodiments of an indoor testing station 10. As shown, the testing station 10 includes an environmentally controlled chamber 12 having an enclosed structure, such as a building. The environmentally controlled chamber 12 defines an interior space 14 in a three-dimensional X-Y-Z coordinate frame, according to the present disclosure.

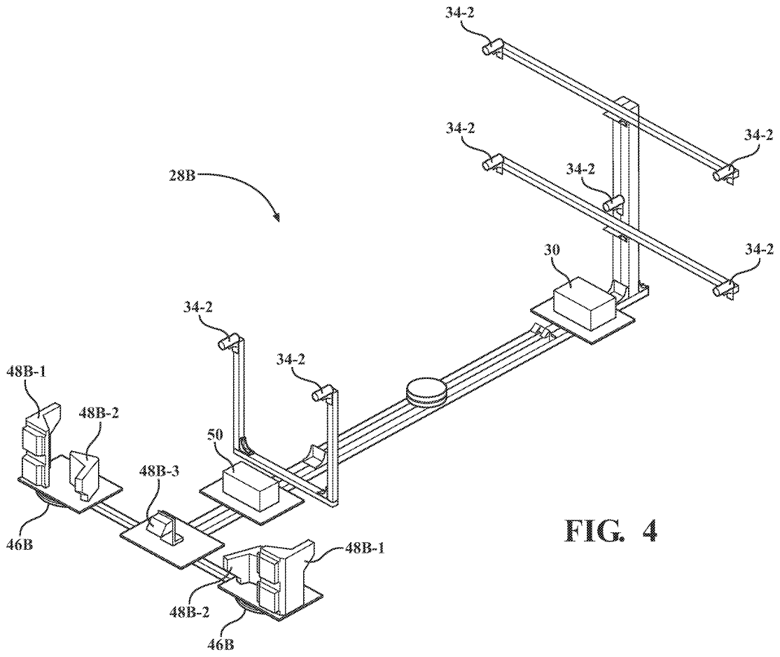

As shown in FIGS. 1A and 1B, the interior space 14 of the chamber 12 accommodates a system 16 configured to evaluate a headlamp assembly 18 for a motor vehicle. Specific requirements for evaluation or testing of motor vehicle headlamp assemblies may be established by vehicle safety governing bodies, such as the National Highway Traffic Safety Administration (NHTSA), and/or vehicle manufacturers. In a particular embodiment, the headlamp assembly 18 being evaluated by the system 16 may utilize adaptive driving beam (ADB) technology (shown in FIG. 5), to be addressed in detail below. The environmentally controlled chamber 12 for the testing station 10 may be specifically configured to reduce uncertainties typically encountered during testing, especially using road vehicles, generated by changes in weather and/or surface conditions in an uncontrolled testing environment, such as an outdoor test track or a public road. Such a chamber may provide appropriate illumination (ambient lighting is adjustable to below 0.2 lux), temperature (20-30 degrees Celsius) and humidity (dry, with no precipitation), and still air.

Generally, headlamp assemblies provide illumination ahead of a host motor vehicle, i.e., illuminate a road surface ahead of the vehicle with projected and specifically aimed light-beams of variable intensity. In on-highway motor vehicle applications, the light-beam each headlamp assembly is required to alternatively produce may be composed of a driving or high beam and a low beam. Typically, a high beam casts most of its light straight ahead, maximizing seeing distance for the host vehicle's operator, but also producing significant glare for other vehicles present on the road. Because high beams have no specific control of upward light, high beams typically also cause significant glare and backdazzle from fog, rain, and snow due to the retroreflection (reflection back to the source with minimum scattering) of the water droplets. On the other hand, a low beam has stricter control of upward light, and directs most of its light downward and to the side, specifically away from oncoming traffic, to provide forward visibility without excessive glare or backdazzle.

ADB technology generally employs arrays of light-emitting diodes (LEDs) configured to form additive sections of a driving beam light pattern generated by the headlamp assembly. In the vehicle, with the aid of an electronic controller in communication with a vehicle camera configured to detect a view of a terrain, an ADB headlamp assembly may adjust its light-beam pattern to objects or vehicles in oncoming or leading traffic. An ADB headlamp assembly may therefore be operated to provide enhanced forward visibility without excessive glare or blinding other road users. Accordingly, the ADB headlamp assembly 18 to be evaluated by the system 16 may include particularly defined light segment arrays 18-1 (shown in FIG. 5) selectable to generate a plurality of beam patterns. The evaluated headlamp assembly 18 (including the ADB headlamp) may be electronically connected to a microprocessor supplied by the vehicle manufacturer for the headlamp evaluation. The supplied manufacturer's microprocessor is typically configured to regulate the subject headlamp assembly 18 when the headlamp assembly is used in an actual vehicle.

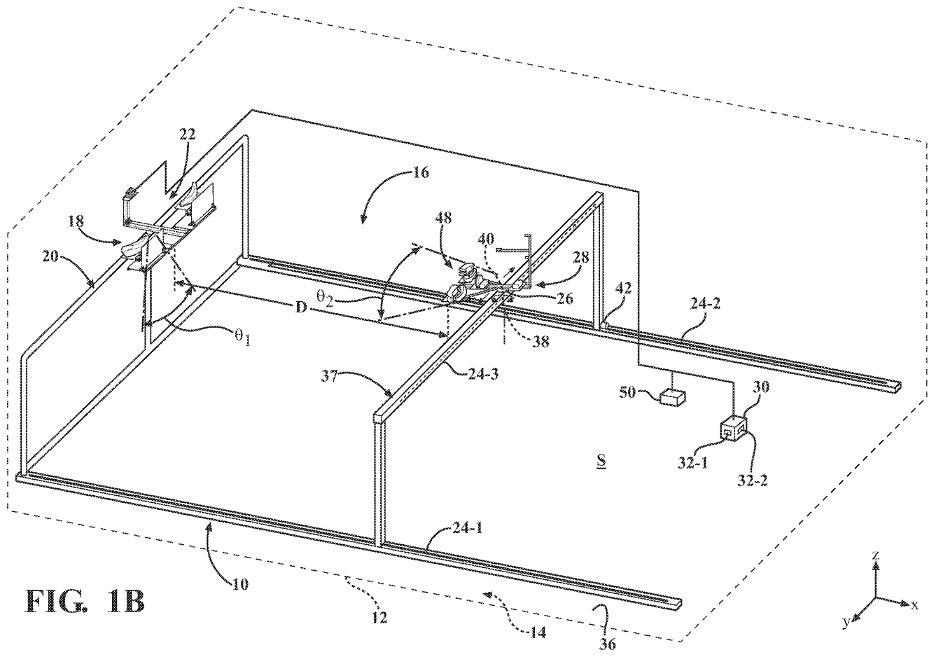

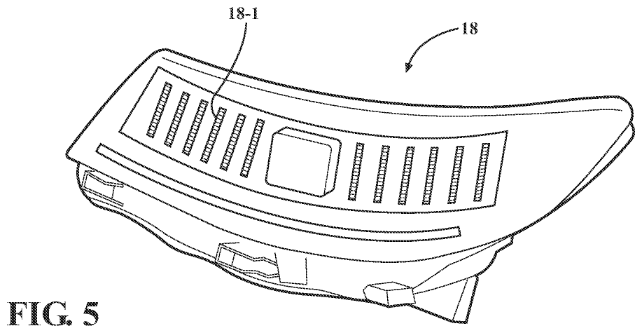

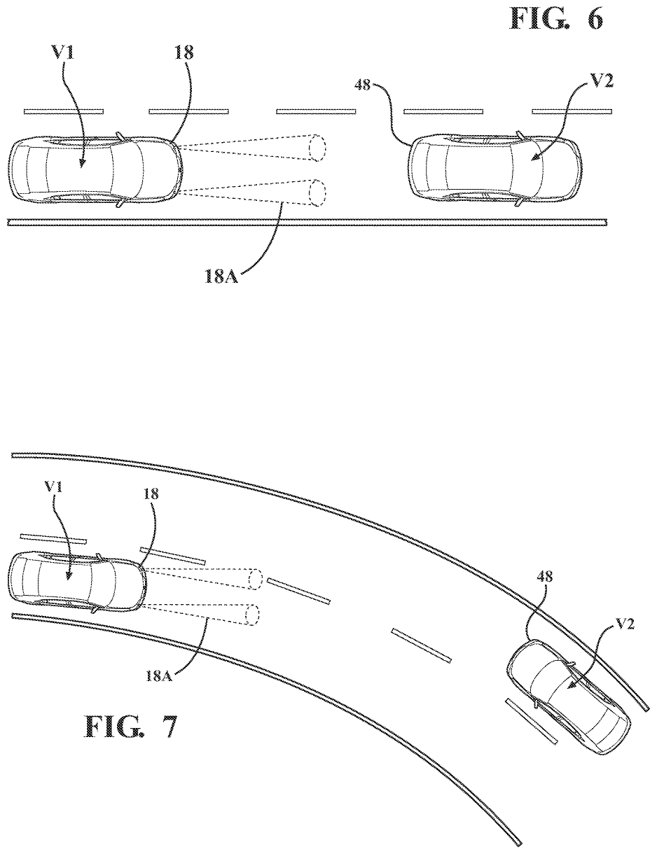

As shown in FIGS. 1A and 1B, the system 16 includes a panel or frame 20 arranged within the interior space 14 of the chamber 12 in the X-Y-Z coordinate frame. The panel 20 may be a rigid structure formed of slender rigid pieces or beams. The system 16 may also include a platform 21 (shown in FIG. 1A) arranged within the interior space 14 in the X-Y-Z coordinate frame, such that the panel 20 is integrated into the platform. The system 16 additionally includes a first fixture 22 (shown in FIGS. 1A and 1B, and 2), which may be configured as a stationary vehicle simulator, i.e., representing a first motor vehicle V1 (shown in FIGS. 6 and 7). The first fixture 22 is configured to support the headlamp assembly 18 adjustably mounted thereto, while the first fixture itself is adjustably mounted to the panel 20. The first fixture 22 may be constructed from fastened beam sections of a rigid and light material, such as aluminum.

The system 16 further includes a first rail 24-1 and a second rail 24-2, each of the rails being parallel to an X-axis. The first and second rails 24-1, 24-2 may be mounted to the platform 21 (as shown in FIG. TA) or directly at base or floor level within the interior space 14 (as shown in FIG. 1B). The system 16 additionally includes a moveable third rail 24-3 arranged transverse to the X-axis on a Y-axis. The third rail 24-3 is configured to engage and traverse the parallel first and second rails 24-1, 24-2 along the X-axis, such that the third rail selectively shifts toward and away from the panel 20. The third rail 24-3 may engage and slide relative to the first and second rails 24-1, 24-2 via specifically configured tracks and/or rollers (not shown). The platform 21, as well as the first, second, and third rails 24-1, 24-2, may be constructed from sections of steel or aluminum to maintain a rigid and precise structure. As shown in FIG. TA, the first fixture 22 may be arranged substantially below the first and second rails 24-1, 24-2, or, as shown in FIG. 1B, substantially above the subject first and second rails.

The vehicle manufacturer's microprocessor (not shown) may also be mounted to the first fixture 22. The first fixture 22 may be selectively adjustable, either manually or via electro-mechanical means to be shifted, e.g., positionally adjusted, relative to the platform 21. The first fixture 22 may be configured to selectively pitch about the Z-axis and along the X-axis, turn and tilt side-to-side about the Z-axis, and shift back-forth along the Y-axis. Specifically, the first fixture 22 may be configured to tilt (defined by angle θ₁) in a range of 0-5% (0-10 degrees) relative to a horizontal (X-Y) plane to simulate a superelevation or camber of a road surface through a curve. The tilting and position setting of the first fixture 22 may be accomplished manually or via a servomechanism (not shown). The first fixture 22 may be constructed from fastened beam sections of a suitably rigid and light material, such as aluminum, to securely support the headlamp assembly 18, the manufacturer's microprocessor, and a mechanism configured to adjust the second fixture as described above.

The system 16 additionally includes a rotary table 26 (shown in FIGS. 1A and 1B) mounted to the third rail 24-3 orthogonal to each of the Y-axis and the third rail. As shown, the rotary table 26 may extend below the third rail 24-3. The rotary table 26 is configured to selectively shift along the third rail 24-3, i.e., along the Y-axis. The rotary table 26 is additionally configured to selectively shift along the Z-axis. The rotary table 26 is further configured to selectively shift or turn about the Z-axis axis in an X-Y plane to vary its angular orientation (defined by angle θ₂) relative to the headlamp assembly 18 on test. Specifically, the rotary table 26 may be configured to turn in a range of up to +/−90 degrees relative to the X-axis. The system 16 additionally includes a second test fixture 28 (embodiments of which are shown in FIGS. 1A, 1B, 3, and 4), which may be arranged substantially below the first and second rails 24-1, 24-2. The second test fixture 28 may be mounted to the rotary table 26 and support a stimulus representing or simulating a lighting system. Similar to the first fixture 22, the second fixture 28 may be constructed from fastened beam sections of a rigid and light material, such as aluminum, to support the stimulus lighting system, sensors (to be described in detail below), and a corresponding mechanism configured to adjust the second fixture as described above. The lighting system simulated by the second fixture 28 may be taillamp(s) or headlamp(s) of a second motor vehicle V2 (such as shown in FIGS. 6 and 7).

The third rail 24-3 is configured to selectively shift the second fixture 28 toward and away from the first fixture 22. Additionally, the second fixture 28 may be adjustable relative to the third rail 24-3. Specifically, the second fixture 28 may be configured to selectively pitch about the Z-axis and along the X-axis, turn and tilt side-to-side about the Z-axis, shift back-forth on the third rail 24-3 along the Y-axis, shift back-forth along the X-axis, pitch about the Z-axis, and shift up-down along the Z-axis. Accordingly, the movement of the second fixture 28 relative to the first fixture 22 is intended to simulate relative motion between the first and second vehicles when the two vehicles encounter each other in real world situations. Specifically, relative motion of the first and second fixtures 22, 28 may be controlled to represent and simulate relative motion of the first and second motor vehicles traveling in same direction, as shown in FIG. 6, and traveling in opposite directions, as shown in FIG. 7.

The provided movement of the second fixture 28 relative to the first fixture 22 makes simulation of forward, backward, leftward, and rightward, movement between the two vehicles possible. The system 16 may be configured to evaluate the headlamp assembly 18 in situations simulating the second vehicle being approached generally head-on (traveling in opposite direction) or from behind (traveling in same direction) by the first vehicle. The system 16 further includes an electronic controller 30 in operative communication with the third rail 24-3 and the rotary table 26 and is programmed with an algorithm 32-1. The electronic controller 30 is configured to execute the algorithm 32-1 to regulate movement of the third rail 24-3 and the rotary table 26. Thus controlled, the movement of the third rail 24-3 and the rotary table 26 is intended to simulate relative motion between the first and second motor vehicles, as represented by the first and second fixtures 22, 28, during operation of the headlamp assembly 18 for evaluating the performance thereof.

The electronic controller 30 includes a memory that is tangible and non-transitory. The memory may be a recordable medium that participates in providing computer-readable data or process instructions. Such a medium may take many forms, including but not limited to non-volatile media and volatile media. Non-volatile media used by the electronic controller 30 may include, for example, optical or magnetic disks and other persistent memory. The electronic controller 30 includes an algorithm that may be implemented as an electronic circuit, e.g., FPGA, or as an algorithm saved to non-volatile memory. Volatile media of the electronic controller 30 memory may include, for example, dynamic random-access memory (DRAM), which may constitute a main memory.

The electronic controller 30 may specifically communicate with the third rail 24-3 and the rotary table 26. Subject communication maybe accomplished via a signal transmission medium, such as coaxial cables, copper wire and fiber optics, and wires in a system bus, for example, coupling the electronic controller 30 to actuators for the third rail 24-3 and the rotary table 26 (to be discussed in detail below). Memory of the electronic controller 30 may also include a flexible disk, hard disk, magnetic tape, other magnetic medium, a CD-ROM, DVD, other optical medium, etc. The electronic controller 30 may be equipped with a high-speed primary clock, requisite Analog-to-Digital (A/D) and/or Digital-to-Analog (D/A) circuitry, input/output circuitry and devices (I/O), as well as appropriate signal conditioning and/or buffer circuitry. Algorithms required by the electronic controller 30 or accessible thereby may be stored in the controller memory and automatically executed to provide the required functionality.

The manufacturer's microprocessor may be configured to regulate operation of the headlamp assembly 18 on test, such as by turning off the driving beam or aiming the headlamp beam away from the second vehicle, i.e., the second fixture 28. In the case of the ADB headlamp assembly 18, the manufacturer's microprocessor may be configured to regulate operation of the headlamp assembly to generate a predetermined light-beam pattern 18A. Specifically, such a predetermined light-beam pattern 18A may be achieved by turning on and off at least a portion of the ADB light segment array, in response to the movement of the third rail 24-3 and the rotary table 26. In one example, the manufacturer's microprocessor may turn off a particular light segment array(s) of the ADB headlamp assembly 18 to arrive at a predetermined beam pattern. In another example, the manufacturer's microprocessor may regulate the ADB headlamp assembly 18 to switch from one beam pattern to another beam pattern by progressively dimming at least one of the light segment arrays, thereby reducing the light intensity of the ADB light beam aimed at the second fixture 28.

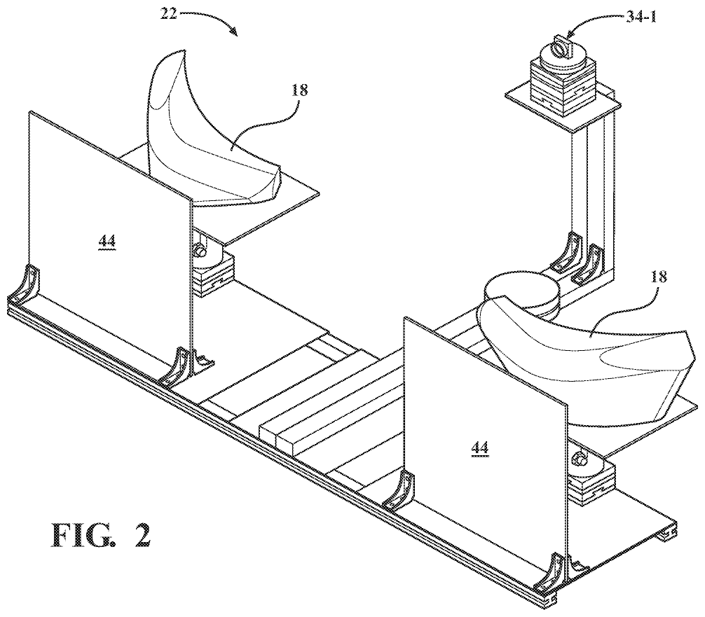

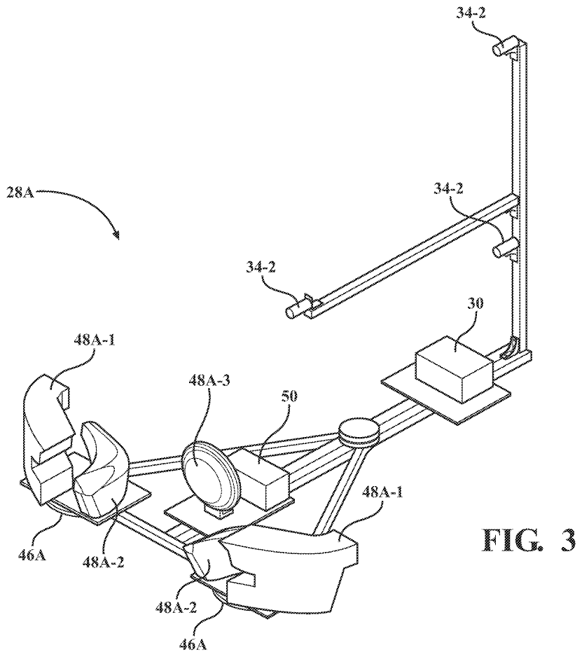

The electronic controller 30 may be in communication with, i.e., is configured to receive, process, and store into memory raw data signals captured or gathered by, sensors, such as a first sensor 34-1 (shown in FIG. 2) and one or more second sensors 34-2 (shown in FIGS. 3 and 4). Specifically, the system 16 may include an array of second sensors 34-2. The first sensor 34-1 is in communication with the electronic controller 30 and is part of the system 18. Specifically, the first sensor 34-1 is a distance measurement device, such as a laser. The first sensor 34-1 may be adjustably mounted to the first fixture 22 and be configured to detect a distance D between the first fixture 22 and the second fixture 28. The first sensor 34-1 may be selectively pitched about the Z-axis and along the X-axis, turn and tilt side-to-side about the Z-axis, shift back-forth along the X-axis, and pitch about the Z-axis. Following its adjustment, the first sensor 34-1 may be fixed relative to the first fixture 22 in the selected position. The second sensors 34-2 are specifically configured to detect performance of the headlamp assembly 18. The electronic controller 30 may be in wired communication with the second sensor(s) 34-2. Performance of the headlamp assembly 18 detected by the second sensors 34-2 may include the generated beam pattern 18A and respective glare resulting therefrom. Specifically, the second sensors 34-2 may be configured as an array of photometers or LUX meters mounted to the second fixture 28 and set up to detect luminous intensity and luminous flux from the ADB headlamp assembly 18 mounted to the first fixture 22.

Requirements and test constraints for the second sensor(s) 34-2 may be as follows:
Measurement sensitivity—0.01 Lux minimum.
Lens must be clean and free from dirt and debris.
Zero-calibrated for each test to account for ambient light.
Photometer color response—corrected to an official standard, such as the 1931 CIE Standard Observer (2-degree) Photopic Response Curve, as shown in the CIE 1931 Chromaticity Diagram (see § 571.5), with a cosine correction characteristic within 3%.
Illuminance data collection at a rate of at least 100 Hz and at a maximum 25-degree angle of incidence.
   Exemplary photometry requirements for the second sensors 34-2 versus measurement distance intervals are shown in Table I directly below:

| | MAXIMUM | |
|---|---|---|
| | ILLUMINANCE | MAXIMUM |
| MEASUREMENT | OPPOSITE | ILLUMINANCE |
| DISTANCE | DIRECTION | SAME DIRECTION |
| INTERVAL (m) | (Lux) | (Lux) |
| Greater than or | 3.1 | 18.9 |
| equal to 15.0 and | | |
| less than 30.0 | | |
| Greater than or | 1.8 | 18.9 |
| equal to 30.0 and | | |
| less than 60.0 | | |
| Greater than or | 0.6 | 4 |
| equal to 60.0 and | | |
| less than 120.0 | | |
| Greater than or | 0.3 | N/A |
| equal to 120.0 and | | |
| less than or equal | | |
| to 220 | | |

With resumed reference to FIGS. 1A and 1B, the platform 21 may include a gantry or supporting structure 21A. As shown in FIG. 1A, the supporting structure 21A may define an under-platform three-dimensional space S between the parallel first and second rails having a height, a width, and a length. Additionally, as also shown in FIG. 1A, the parallel first rail 24-1 and second rail 24-2 may be mounted to the supporting structure 21A at a predetermined height or elevation above a floor or foundation 36 of the chamber 12. Furthermore, as noted above, the rotary table 26 with the second test fixture 28 may hang below the third rail 24-3, thus extending into the under-platform space S (as shown in FIG. 1A). Alternatively, as shown in FIG. 1B, the rotary table 26 with the second test fixture 28 may be situated on top of the third rail 24-3, thus being arranged to operate above the under-platform space S. As also shown in FIG. 1B, the parallel first rail 24-1 and second rail 24-2 may be mounted proximate to or directly to the foundation 36. In such an embodiment, the third rail 24-3 may be part of a cross-bridge 37 spanning a distance between the parallel first and second rails 24-1, 24-2. The cross-bridge 37 is configured to position the third rail 24-3 at a predetermined height relative to the parallel first and second rails 24-1, 24-2 and the foundation 36, and traverse the parallel first and second rails 24-1, 24-2 at the subject height. Consistently with the alternatives laid out above, the rotary table 26 with the second test fixture 28 may be mounted to the third rail 24-3 either under the cross-bridge 37 or over, i.e., above, the cross-bridge. As shown in FIG. 1B, movement of the cross-bridge 37 along the parallel first and second rails 24-1, 24-2 may thereby effectively define an under-bridge three-dimensional space S.

As shown in FIG. 1B, the rotary table 26 with the attached second test fixture 28 may be mounted above the third rail 24-3, thus being positioned above or outside the under-platform space S. Alternatively, although not shown, but analogously to the arrangement shown in FIG. 1A, in the embodiment of FIG. 1B, the rotary table 26 and the second test fixture 28 may hang below the third rail 24-3, thus extending into the under-bridge space S. Additionally, the first fixture 22 may be mounted either below the panel 20 (shown in FIG. 1A) or above the subject panel (shown in FIG. 1B). Such mounting of the first fixture 22 may be selected, for example, to correlate with the mounting and elevation of the second fixture 28. In either FIG. 1A or FIG. 1B, the third rail 24-3 will traverse the supporting structure 21A, along the X-axis, above the foundation 36. The system 16 may also include a plurality of actuators to impart motion to the third rail 24-3 and the rotary table 26. Specifically, such system actuators may be configured as respective electric motors described below.

As shown in FIGS. 1A and 1B, a first electric motor 38 may be configured to turn the rotary table 26 relative to third rail 24-3 about the Z-axis. A second electric motor 40 may be configured to shift the rotary table 26 along the third rail 24-3, i.e., along the Y-axis. A third electric motor 42 may be configured to shift the third rail 24-3 relative to the parallel first and second rails 24-1, 24-2. As shown, each of the first, second, and third electric motors 38, 40, 42 is in operative communication with the electronic controller 30. Specific instructions for operating the three electric motors 38, 40, 42 during the evaluation of the headlamp assembly 18 may be included in the algorithm 32-1 programmed into electronic controller 30. Accordingly, the motion of the rotary table 26, the third rail 24-3 via the respective electric motors 38, 40, 42 may be programmed to simulate relative motion of the first and second vehicles traversing straight roads and road curves having distinct radii.

Sample stimuli (simulating the second vehicle's lighting system) to be mounted on the second test fixture 28 and configured to satisfy testing requirements may be as follows:
1) Headlamps: lower beam energized at 12.8 volts DC+/−500 mV
Truck: 2018 Ford F-150 Halogen headlamp.
Passenger Car: 2018 Toyota Camry LED headlamp.
Motorcycle: 2018 Harley Davidson Sportster using an HB2 replaceable light source.
2) Taillamps: energized at 12.8 volts DC+/−500 mV
Truck: 2018 Ford F-150 incandescent rear combination lamp.
Passenger Car: 2018 Toyota Camry rear combination lamp.
Motorcycle: 2018 Harley Davidson Roadster Layback LED taillamp assembly.

An exemplary test matrix delineating eight scenarios for the evaluation of a representative headlamp assembly is shown in Table II directly below:

| | Test | | | | | | System 16 |
|---|---|---|---|---|---|---|---|
| | Vehicle | | Curve | | Super- | Measurement | Simulation |
| Scenario | Speed | Test Vehicle | Radius | Curve | elevation | Distance | Conversion |
| Number | (kph) | Orientation | (m) | Direction | (%) | Range (m) | (m) |
| 1 | 96.6-112.7 | Opposite | Straight | N/A | 0-2 | Greater than | 15 → 1.5 |
| | [60-70 | Direction | | | | or equal to 15 | 220 → 22 |
| | mph] | | | | | and less than | |
| | | | | | | or equal to 220 | |
| 2 | 40.2-48.3 | Opposite | 85-115 | Left | 0-2 | Greater than | 15 → 1.5 |
| | [25-30 | Direction | | | | or equal to 15 | 60 → 6 |
| | mph] | | | | | and less than 60 | |
| 3 | 64.4-72.4 | Opposite | 200-250 | Left | 0-2 | Greater than | 15 → 1.5 |
| | [40-45 | Direction | | | | or equal to 15 | 150 → 15 |
| | mph] | | | | | and less than | |
| | | | | | | or equal to 150 | |
| 4 | 80.5-88.5 | Opposite | 335-400 | Left | 0-2 | Greater than | 15 → 1.5 |
| | [50-55 | Direction | | | | or equal to 15 | 220 → 22 |
| | mph] | | | | | and less than | |
| | | | | | | or equal to 220 | |
| 5 | 64.4-72.4 | Opposite | 200-250 | Right | 0-2 | Greater than | 15 → 1.5 |
| | [40-45 | Direction | | | | or equal to 15 | 50 → 5 |
| | mph] | | | | | and less than | |
| | | | | | | or equal to 50 | |
| 6 | 80.5-88.5 | Opposite | 335-400 | Right | 0-2 | Greater than | 15 → 1.5 |
| | [50-55 | Direction | | | | or equal to 15 | 70 → 7 |
| | mph] | | | | | and less than | |
| | | | | | | or equal to 70 | |
| 7 | 96.6-112.7 | Same | Straight | N/A | 0-2 | Greater than | 15 → 1.5 |
| | [60-70 | Direction | | | | or equal to 15 | 100 → 10 |
| | mph] | | | | | and less than | |
| | | | | | | or equal to 100 | |
| 8 | 64.4-72.4 | Same | 200-250 | N/A | 0-2 | Greater than | 15 → 1.5 |
| | [40-45 | Direction | | | | or equal to 15 | 100 → 10 |
| | mph] | | | | | and less than | |
| | | | | | | or equal to 100 | |

Specific stipulations for the above testing matrix may include the following:
Filters with 1% transmittance are used with sensors 34-1 to detect the distance D.
A 4-pole connected lamp holder is used to eliminate voltage drop.
The Inverse-square law is complied with during the process.

The second fixture 28 is configured to mount thereon at least one lighting stimulus 48 (shown in FIGS. 1A and 1B). The stimuli 48 mounted on the second fixture 28 shown in FIGS. 1A and 1B correspond to stimuli 48 shown as vehicle taillights and headlights, respectively, in FIGS. 6 and 7. As shown in FIGS. 3 and 4, the second fixture 28 may include individual second fixture embodiments 28A and 28B to be selectively used during the simulation testing. For example, embodiment 28A of the second fixture shown in FIG. 3 may include left and right rotary plates 46A, each configured to mount thereon a plurality of distinct headlamp stimuli, such as the truck and passenger car headlamp assemblies 48A-1 and 48A-2, respectively. The rotary plates 46A may be further configured to select and generally align each such headlamp assembly 48A-1, 48A-2 with the first fixture 22 during a particular segment of a respective opposite direction vehicle simulation test. The embodiment 28A of the second fixture may additionally centrally mount thereon a motorcycle headlamp assembly 48A-3. On the other hand, embodiment 28B of the second fixture shown in FIG. 4 may include left and right rotary plates 46B, each configured to mount thereon a plurality of distinct taillamp stimuli, such as the truck and passenger car taillamp assemblies 48B-1 and 48B-2, respectively. The rotary plates 46A may be further configured to select and generally align each such taillamp assembly 48B-1, 48B-2 with the first fixture 22 during a particular segment of a respective same direction vehicle simulation test. The embodiment 28B of the second fixture may additionally centrally mount thereon a motorcycle taillamp assembly 48B-3.

The electronic controller 30 may be additionally programmed with calibration software embedded in an algorithm 32-2 configured to tune the testing equipment and the process of evaluating the headlamp assembly 18. For example, the subject algorithm 32-2 may be tasked with initializing and regulating operation of calibration lamps and filters 44 (shown in FIG. 2). Alternatively, the calibration lamps and filters may be operated and adjusted manually for each specific test. The calibration lamp may be a standard illuminant which is a theoretical source of visible light with a defined spectral power distribution. In general, standard illuminants provide a basis for comparing images or colors recorded under different lighting. Specifically, the standard illuminant used for system calibration may be “Illuminant A” intended to represent typical tungsten-filament lighting. As understood by those skilled in the art, the relative spectral power distribution of Illuminant A is that of a Planckian radiator at a temperature of approximately 2856 Kalvin.

The calibration lamp is connected to a power supply 50 and may be in operative communication with the electronic controller 30. The system 16 may also employ multiple calibration filters (not shown) with distinct or variable light transmittance capability. The calibration software may be configured to adjust for the distance D between the first and second fixtures 22, 28 and scale or convert the light intensity of the calibration lamp for the distance D versus a distance between actual vehicles V1, V2 on a road in the real-world. The amount of glare thus detected by the second sensors 34-2 and the distance D detected by the first sensor 34-1 may be used to evaluate the performance of the tested headlamp assembly(s) 18 versus amount of glare specified in predetermined requirements. Such requirements may be specifically established by a vehicle safety governing body, such as the NHTSA.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A system for evaluating performance of a motor vehicle headlamp assembly, the system arranged in an X-Y-Z coordinate frame and comprising:
a first fixture configured to support the headlamp assembly;
first and second rails, each parallel to an X-axis;
a third rail arranged transverse to the X-axis on a Y-axis and configured to traverse the parallel first and second rails such that the third rail selectively shifts toward and away from the first fixture;
a rotary table mounted to the third rail and configured to selectively:
shift along the third rail;
shift along a Z-axis; and
turn about the Z-axis;
a second fixture mounted to the rotary table; and
an electronic controller configured to regulate movement of the third rail and the rotary table to simulate relative motion between first and second motor vehicles represented by the first and second fixtures during operation of the headlamp assembly.

2. The system according to claim 1, wherein the headlamp assembly is an adaptive driving beam (ADB) headlamp assembly including a light segment array selectable to generate a plurality of beam patterns and configured to generate a predetermined beam pattern in response to the movement of the third rail and the rotary table.

3. The system according to claim 1, further comprising a first sensor in communication with the electronic controller, mounted to the first fixture, and configured to detect a distance between the first and second fixtures.

4. The system according to claim 3, wherein the first sensor is a laser measurement device.

5. The system according to claim 3, further comprising at least one second sensor in communication with the electronic controller, mounted to the second fixture, and configured to detect a lighting performance of the headlamp assembly.

6. The system according to claim 5, wherein each second sensor is configured as a LUX meter set up to detect luminous intensity of the headlamp assembly.

7. The system according to claim 1, further comprising a platform including a gantry structure defining an under-platform space between the parallel first and second rails and having a height, a width, and a length;
wherein:
each of the first fixture, the first rail, and the second rail is mounted to the platform; and
each of the rotary table and the second fixture one of extends into the under-platform space and is arranged above the under-platform space.

8. The system according to claim 1, wherein:
the third rail is part of a cross-bridge spanning a distance between the parallel first and second rails, thereby positioning the third rail at a predetermined height relative to the parallel first and second rails; and
each of the rotary table and the second fixture is mounted one of under the cross-bridge and over the cross-bridge.

9. The system according to claim 1, further comprising a first electric motor configured to turn the rotary table about the Z-axis.

10. The system according to claim 1, further comprising a second electric motor configured to shift the rotary table along the third rail.

11. The system according to claim 1, further comprising a third electric motor configured to shift the third rail relative to the parallel first and second rails.

12. A controlled environment indoor testing station for evaluating a motor vehicle headlamp assembly, the indoor testing station comprising:
an enclosed structure defining an interior space in an X-Y-Z coordinate frame;
a first fixture configured to support the headlamp assembly;
first and second rails, each parallel to an X-axis;
a third rail arranged transverse to the X-axis on a Y-axis and configured to traverse the parallel first and second rails such that the third rail selectively shifts toward and away from the first fixture;
a rotary table mounted to the third rail and configured to selectively:
shift along the third rail;
shift along a Z-axis; and
turn about the Z-axis;
a second fixture mounted to the rotary table; and
an electronic controller configured to regulate movement of the third rail and the rotary table to simulate relative motion between first and second motor vehicles represented by the first and second fixtures during operation of the headlamp assembly.

13. The indoor testing station according to claim 12, wherein the headlamp assembly is an adaptive driving beam (ADB) headlamp assembly including a light segment array selectable to generate a plurality of beam patterns and configured to generate a predetermined beam pattern in response to the movement of the third rail and the rotary table.

14. The indoor testing station according to claim 12, further comprising a first sensor in communication with the electronic controller, mounted to the first fixture, and configured to detect a distance between the first and second fixtures.

15. The indoor testing station according to claim 14, wherein the first sensor is a laser measurement device.

16. The indoor testing station according to claim 14, further comprising at least one second sensor in communication with the electronic controller, mounted to the second fixture, and configured to detect a lighting performance of the headlamp assembly.

17. The indoor testing station according to claim 16, wherein each second sensor is configured as a LUX meter set up to detect luminous intensity of the headlamp assembly.

18. The indoor testing station according to claim 12, further comprising a platform including a gantry structure defining an under-platform space between the parallel first and second rails and having a height, a width, and a length,
wherein:
each of the first fixture, the first rail, and the second rail is mounted to the platform; and
each of the rotary table and the second fixture one of extends into the under-platform space and is arranged above the under-platform space.

19. The indoor testing station according to claim 12, wherein:
the third rail is part of a cross-bridge spanning a distance between the parallel first and second rails, thereby positioning the third rail at a predetermined height relative to the parallel first and second rails; and
each of the rotary table and the second fixture is mounted one of under the cross-bridge and over the cross-bridge.

20. The indoor testing station according to claim 12, further comprising a first electric motor configured to turn the rotary table about the Z-axis.

21. The indoor testing station according to claim 12, further comprising a second electric motor configured to shift the rotary table along the third rail.

22. The indoor testing station according to claim 12, further comprising a third electric motor configured to shift the third rail relative to the parallel first and second rails.
